(19) United States
(12) Patent Application Publication
(10) Pub. No.: US 2006/0020764 A1
(43) Pub. Date: Jan. 26, 2006

(54) Information processing apparatus including non-volatile memory device, non-volatile memory device and methods thereof

(76) Inventors: Sun-Kwon Kim, Suwon-si (KR); Byeong-Hoon Lee, Seoul (KR)

Correspondence Address: HARNESS, DICKEY & PIERCE, P.L.C., P.O. BOX 8910, RESTON, VA, 20195, US

(21) Appl. No.: 11/122,027

(22) Filed: May 5, 2005

(30) Foreign Application Priority Data
Jul. 22, 2004 (KR) 2004-57335

(51) Int. Cl. G06F 12/00

(52) U.S. Cl. 711/168

(57) ABSTRACT

An information processing apparatus including, non-volatile memory device, non-volatile memory device and methods thereof. The non-volatile memory device outputs a signal indicating to an external device whether a next command may be executed without a processing interruption. The signal may be based on whether the non-volatile memory device is executing a command when the next command is received.

### CROSS-REFERENCE TO RELATED APPLICATIONS

This U.S. non-provisional patent application claims priority under 35 U.S.C. § 119 of Korean Patent Application 2004-57335 filed on Jul. 22, 2004, the entire contents of which are hereby incorporated by reference.

### BACKGROUND OF THE INVENTION

1. Field of the Invention

The present invention is related generally to an information processing apparatus and method thereof, and more particularly to an information processing apparatus including a non-volatile memory device, a non-volatile memory device and methods thereof.

2. Description of the Related Art

Information processing circuits including a processor may require program code to operate. The program code may be stored in memory. Conventional types of memory that may store program code include Read Only Memory (ROM) and Random Access Memory (RAM). Data may only be read from the ROM and may not be written to the ROM. Data may be written to and/or read from RAM devices. Unlike a ROM, data stored in a RAM device may be lost when a power supply to the RAM is interrupted (e.g., due to a shut down of the information processing circuit).

Non-volatile memory devices may combine the advantages of RAM devices and ROM devices by allowing data to be written to and/or read from the non-volatile memory device while the non-volatile memory device may also maintain its stored contents when a power supply is terminated.

In a conventional non-volatile memory (e.g., a NOR type flash memory), a read operation may last approximately 100 nanoseconds, a program operation may require several hundred microseconds and an erase cycle for a block (i.e., a sector) may last several milliseconds.

One conventional information processing apparatus may include a processor with pipelining functionality. It may be difficult for the processor to complete a task in a single cycle of a clock signal because a write or erase operation of a non-volatile memory device, which may include program code, may have a longer processing time than the single clock cycle. In other words, a pipeline stall may occur when the processor is required to wait for memory from a memory device (e.g., a non-volatile memory device) as opposed to progressing through the pipelined instructions without a stall.

When the processor requires the memory to perform read or write operations while a memory is executing a write operation, a correct operation of the processor may not be certain since the memory cannot acknowledge the request from the processor. Such processing errors may be referred to as data hazards.

Conventional memory devices may include an ability to perform both a read and a write operation at the same time, which may be referred to as a “read-while-write” mode. A memory including the “read-while-write” mode may perform a read operation at the same time as a write operation, and the time required to perform both a read operation and a write operation may thereby be reduced. Implementation of the “read-while-write” mode may require various peripheral circuits built into the memory device (e.g., the non-volatile memory device) and the layout pattern of the memory device may require modification (e.g., to adapt to the required peripheral circuits). Furthermore, the additional peripheral circuits may require additional power as compared to memory devices without the additional peripheral circuits, and a read operation and/or a write operation may be affected by noise (e.g., from the additional required power) which may interfere with the memory function (e.g., increasing the risk of data hazards).

### SUMMARY OF THE INVENTION

An example embodiment of the present invention is a non-volatile memory device including a controller for outputting at least one signal to an external device, the at least one signal indicating whether a memory cell array executing a first command is available to execute a second command, the first command being a write command.

Another example embodiment of the present invention is an information processing apparatus including a processor unit, a non-volatile memory device including a memory cell array, a clock generator for generating a clock signal, the generation of the clock signal stopping in response to a clock disable signal and a controller for activating the clock disable signal when the memory cell array is not available to execute a first command received from the processor unit.

Another example embodiment of the present invention is a method for controlling a non-volatile memory device, including receiving a first command at a non-volatile memory device and outputting at least one signal to an external device, the at least one signal indicating that the first command may be executed when the non-volatile memory device is not executing a second command and indicating that the first command may not be executed when the non-volatile memory device is executing the second command.

Another example embodiment of the present invention is a method for processing, including transmitting a first command to a non-volatile memory device from a processor unit before the non-volatile memory device completes execution for a write operation and pausing an operation of the processor unit in response to at least one signal received from the non-volatile memory device, the at least one signal indicating that the non-volatile memory device cannot execute the first command until the write operation completes execution.

### BRIEF DESCRIPTION OF THE DRAWINGS

The present invention will become more apparent by describing in detail exemplary embodiments thereof with reference to the attached drawings in which:

FIG. 1 illustrates a block diagram of an information processing apparatus according to an example embodiment of the present invention.

FIG. 2 illustrates a circuit diagram of an example embodiment of the mode controller of FIG. 1.

FIG. 3 illustrates an example timing diagram for the information processing apparatus of FIG. 1.

FIG. 4 illustrates another example timing diagram of signals for the information processing apparatus of FIG. 1.

FIG. 5 illustrates a block diagram of another information processing apparatus 200 according to an example embodiment of the present invention.

FIG. 6 illustrates a flow chart of a process according to an example embodiment of the present invention.

FIG. 7 illustrates a flow chart of another process according to another example embodiment of the present invention.

### DETAILED DESCRIPTION OF EXAMPLE EMBODIMENTS OF THE PRESENT INVENTION

Hereinafter, example embodiments of the present invention will be described in detail with reference to the accompanying drawings.

In the Figures, the same reference numerals are used to denote the same elements throughout the drawings.

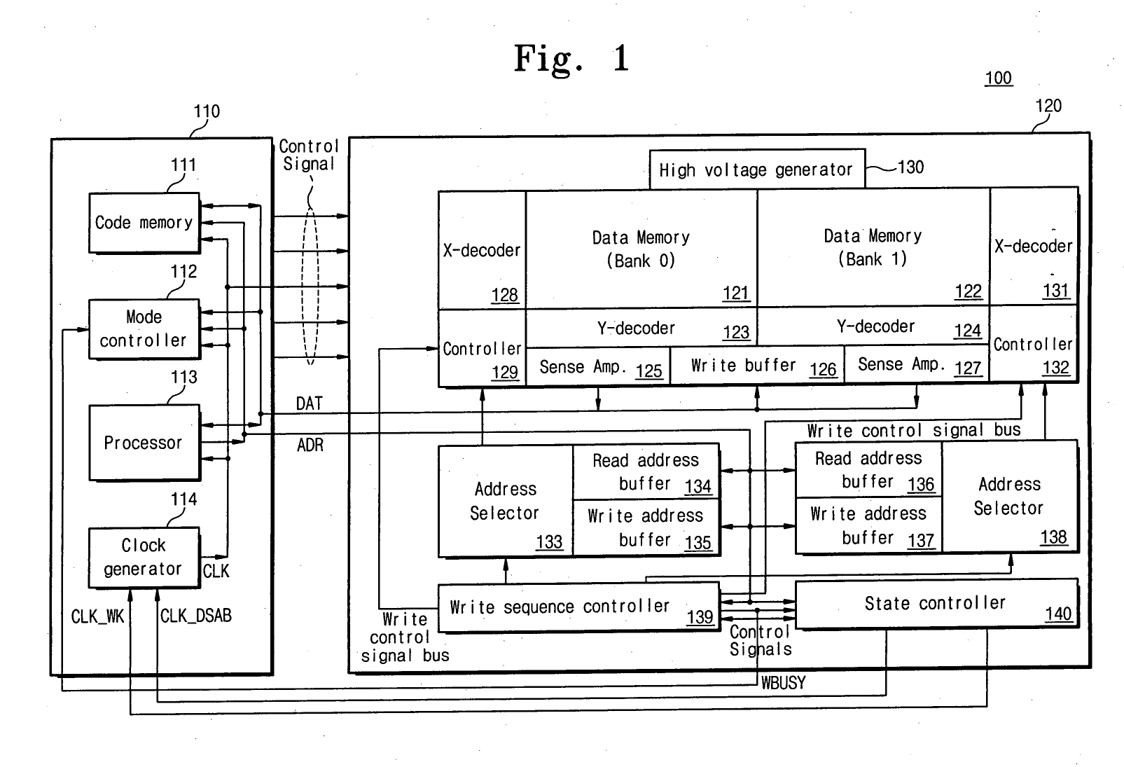

FIG. 1 illustrates a block diagram of an information processing apparatus 100 according to an example embodiment of the present invention.

Referring to FIG. 1, the information processing apparatus 100 may include a processor unit 110 and/or a non-volatile memory device 120.

In another example embodiment of the present invention, the information processing apparatus 100 may be implemented as any device including a processor unit and a non-volatile memory device. For example, the information processing apparatus 100 may include a computer system, a smart card, a Personal Digital Assistant (PDA), a portable phone, etc.

In another example embodiment of the present invention, the non-volatile memory device 120 may include an Electrically Erasable Programmable Read Only Memory (EEPROM), EPROM, and/or a flash memory. Non-volatile memory devices may not lose data stored in memory when electric power supplied thereto is interrupted and/or shut down.

The processor unit 110 may include a code memory 111, a mode controller 112, a processor 113, and/or a clock generator 114. Each of the code memory 111, the mode controller 112, the processor 113, and/or the clock generator 114 may be connected with one another through a data bus and/or an address bus.

The code memory 111 may store program code which may be processed in the processor 113. The mode controller 112 may latch a program command PGM issued from the processor 113 based on an operation status (e.g., whether instruction execution is available) of the non-volatile memory device 120.

In another example embodiment of the present invention, although the mode controller 112 has been above-described as latching the program command PGM, it may also latch memory control commands (e.g., an erase command) that may be executed within one clock cycle.

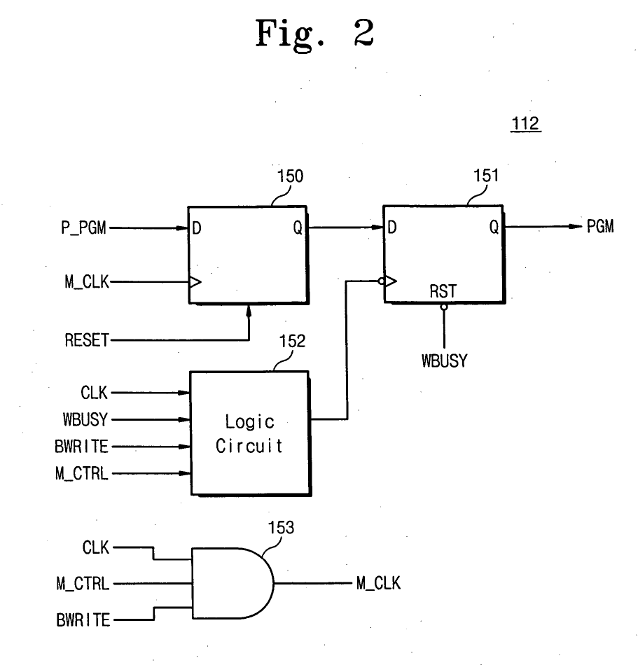

FIG. 2 illustrates a circuit diagram of an example embodiment of the mode controller 112 of FIG. 1.

Referring to FIG. 2, the mode controller 112 may include first and second flip-flop circuits 150 and 151, a logic circuit 152, and an AND gate 153. The AND gate 153 may receive a clock signal CLK, a busy signal WBUSY, a write signal BWRITE, and a control signal M_CTRL, and may output a clock signal M_CLK. The first flip-flop circuit 150 may latch a program command signal P_PGM from the processor 113 in response to the clock signal M_CLK. The first flip-flop circuit 150 may be reset in response to a reset signal RESET. The logic circuit 152 may output a pulse signal in response to the clock signal CLK, the busy signal WBUSY, the write signal BWRITE, and/or the control signal M_CTRL. The control signal M_CTRL may be activated when the mode controller 112 is selected by the processor 113. The second flip-flop circuit 151 may latch an output from the first flip-flop circuit 150 in response to the pulse signal output from the logic circuit 152, and may output a program command signal PGM. The flip-flop circuit 151 may be reset at a falling edge of the busy signal WBUSY which may be received from the non-volatile memory device 120. The program command signal PGM received from the mode controller 112 may be output to the non-volatile memory device 120.

In another example embodiment of the present invention, referring to FIG. 1, the processor 113 may sequentially read and execute program code stored in the code memory 111. The clock generator 114 may generate a clock signal CLK which may be used by the code memory 111, the mode controller 112, the processor 113, and/or any other device to which it is connected. The clock generator 114 may stop generation of the clock signal CLK when a clock disable signal CLK_DSAB from the non-volatile memory device 102 is activated (i.e., set to a first logic level). The clock generator 114 may regenerate the clock signal CLK when a clock wake-up signal CLK_WK is activated.

In another example embodiment of the present invention, the processor 110 may output command signals PGM, ERA, BWRITE, the clock signal CLK, and/or a chip-selecting signal CS to the non-volatile memory device 120.

In another example embodiment of the present invention, the non-volatile memory device 120 may execute read/write/erase operations based on a control signal (e.g. the program command signal PGM, an erase command ERA, the clock signal CLK, the chip-selecting signal CS, the write signal BWRITE, a data signal DAT, an address signal ADR from the processor unit 110, etc.).

Although the described non-volatile memory device 120 may include two memory banks 121 and 122, it is understood that the number of the banks is not limited to two memory banks, and rather that any number of memory banks may be included in other example embodiments of the present invention.

In another example embodiment of the present invention, referring to FIG. 1, each of the memory banks 121 and 122 may include data, and memory cells that are arranged in rows and columns. The non-volatile memory device 120 may include a first X-decoder 128 for selecting rows of bank-0 121, a first Y-decoder 123 for selecting columns thereof, and a first sense amplifier 125 for sensing and amplifying data stored in a memory cell of the bank-0 121 (alternatively referred to as “data memory 121” and/or “memory bank 121”) which may be selected by the first X- and Y-decoders 128 and 125. The non-volatile memory device 120 may also include a second X-decoder 131 for selecting rows of bank-1 122 (alternatively referred to as “data memory 122” and/or “memory bank 122”), a second Y-decoder 124 for selecting columns thereof, and a second sense amplifier 127 for sensing and amplifying data stored in a memory cell of the bank-1 122 selected by the second X- and Y-decoders 131 and 127.

In another example embodiment of the present invention, a high voltage generator 130 may generate and output higher voltages (e.g., above a threshold required for operations such as writing data, reading data, erasing data, etc.) to or from the banks 121 and 122. A write buffer 126 may temporarily store data to be written to the banks 121 and 122. One high voltage generator and one write buffer may be included in the non-volatile memory device 102 such that the banks 121 and 122 may use both the high voltage generator and the write buffer.

In another example embodiment of the present invention, a first controller 129 may control the first X- and Y-decoders 128 and 123, the write buffer 126, and the high voltage generator 130 in response to a control signal from a write sequence controller 139 and/or an address signal from a first address selector 133 such that data DAT from the processor unit 110 may be stored in the bank-0 121. A second controller 132 may control the first X- and Y-decoders 131 and 124, the write buffer 126, and the high voltage generator 130 such that, in response to a control signal from a write sequence controller 139 and/or an address signal from a second address selector 138, data DAT from the processor unit 110 may be stored in the bank-1 122.

In another example embodiment of the present invention, referring to FIG. 1, first and second read address buffers 134 and 136 and first and second write address buffers 135 and 137 may store an address signal ADR received from the processor unit 110. The first address selector 133 may output the address signal stored in either of the first read and write address buffers 134 and 135 to the first controller 129. The second address selector 138 may provide the address signal stored in either of the second read and write address buffers 136 and 137 to the second controller 132.

In another example embodiment of the present invention, the write sequence controller 139 may generate control signals to control the first and second address selectors 133 and 138 and/or the first and second controllers 129 and 132 in response to at least one control signal (e.g., PGM, ERA, and BWRITE, the chip-selecting signal CS, a confirmation signal CONF, the clock signal CLK from the processor unit 110, etc.). The write sequence controller 139 may further activate (i.e., set to the first logic level) a busy signal WBUSY while data is written into the bank-0 121 and/or the bank-1 121. The busy signal WBUSY may be received by a state controller 140 and/or the mode controller 112 of the processor unit 110.

The state controller 140 may generate a clock disable signal CLK_DSAB and/or a clock wake-up signal CLK_WK for controlling the clock generator 114 of the processor unit 110 in response to the at least one control signal (e.g., PGM, ERA, and BWRITE from the processor unit 110, the busy signal WBUSY from the write sequence controller 139, etc.).

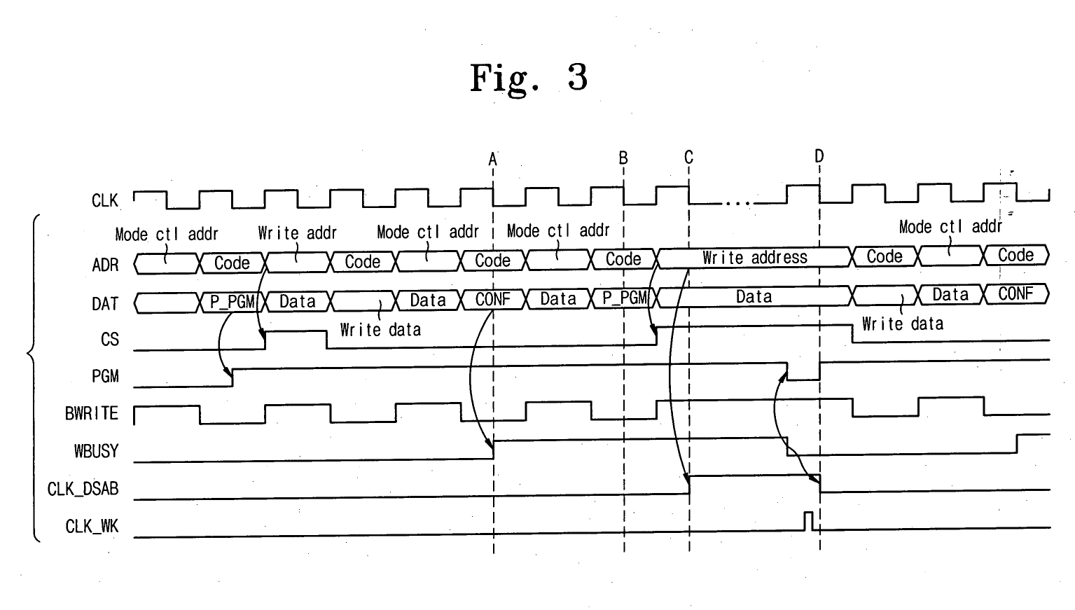

FIG. 3 illustrates an example timing diagram for the information processing apparatus 100 of FIG. 1. In this example, a processor unit 110 may output a program command to a non-volatile memory device 120 during a program operation in the non-volatile memory device 120.

In another example embodiment of the present invention, referring to FIG. 3, when it is detected that a command read out from the code memory 111 is a program command P_PGM, the processor 113 may output an address signal for the mode controller 112 to the address bus. When the mode controller 112 is selected by the processor 113, a control signal M_CLK may be activated. When the control signal M_CLK is activated, the logic circuit 152 may output a pulse signal (e.g., since the busy signal WBUSY is at a second logic level). The second flip-flop circuit 151 may output a signal latched by the first flip-flop circuit 150 as a program signal PGM at the falling edge of the clock signal CLK in response to the pulse signal from the logic circuit 152.

In another example embodiment of the present invention, when the chip-selecting signal CS is activated, a write address and data may be loaded onto the address bus and the data bus, respectively, and may be accessible to the non-volatile memory device 120 (e.g., via the respective buses). The write address may serve to designate a memory bank (e.g., the bank-0 121). An address signal ADR from the processor unit 110 may be stored in a write address buffer 135 of the non-volatile memory device 120.

Program code and data may be loaded onto the address bus and the data bus, thereby enabling the processor 113 to execute a next command. The processor 113 may again output the address signal for selecting the mode controller 112. The mode controller 112 may transmit a confirmation signal CONF to the non-volatile memory device 120 in response to the address signal from the processor 113.

Referring to FIG. 3, at time A, when the confirmation signal CONF is applied to the non-volatile memory device 120 from the processor unit 110, a program operation may begin. The write sequence controller 139 may activate the busy signal WBUSY. The first address selector 133 may output the address, which may be stored in the first write address buffer 135, to the first controller 129. Accordingly, a program operation for the bank-0 121 may be executed under the control of the first controller 129. When the busy signal WBUSY is in an active state, the mode controller 112 may delay the output of the next program code from the processor 113. After the non-volatile memory device 120 executes the program operation, the processor unit 110 may receive and process the next program code from the code memory 111.

Referring to FIG. 3, at time B, when the non-volatile memory device 120 executes (e.g., carries out the write/read operation) the program operation for the bank-0 121, the next program command P_PGM from the processor 113 may be latched in the first flip-flop circuit 150 of FIG. 2.

In the interval between time B and time C, the processor 113 may output a write address to the non-volatile memory device 120 and may enable the chip-selecting signal CS.

At time C, the state controller 140 may activate the busy signal WBUSY when the chip-selecting signal CS is activated. When the write signal BWRITE is at the first logic level (e.g., a low logic level, a high logic level, etc.), the state controller 140 may activate a clock disable signal CLK_DSAB. When the non-volatile memory device 120 executes a write operation and each of the chip-selecting signal CS and the write signal BWRITE are activated, a clock disable signal CLK_DSAB, which may suspend an operation for the processor 113, may be activated irrespective of whether a write address ADR designates the bank-0 121 or the bank-1 122.

In the interval between time C and time D, when the program operation for the bank-0 121 is terminated, the write sequence controller 139 may set the busy signal WBUSY to the second logic level (e.g., a high logic level, a low logic level, etc.). The write sequence controller 139 may further activate the clock wake-up signal CLK_WK. The second flip-flop circuit 151 of the mode controller 112 may be reset in response to the busy signal WBUSY. As a result, the program signal PGM may be at the second logic level.

At time D, the state controller 140 may be at the second logic level at the falling edge of the clock signal CLK. Since the busy signal WBUSY may be at the second logic level, the mode controller 112 may output a signal latched by the first flip-flop circuit 150 as the program signal PGM. Subsequently, the non-volatile memory device 120 may execute the program operation.

While the non-volatile device 120 executes a write operation, the non-volatile memory device 120 may output an information signal CLK_DSAB (e.g., to an external device) indicating whether a received command may be executed. When the information signal CLK_DSAB is enabled (e.g., set to either the first logic level or the second logic level), the processing unit 110 of the information processing apparatus may stop an operation of the processor 113, thereby preventing a malfunction of the processor 113 (e.g., due to a data hazard). In an example, when the received command is a write command, the mode controller 112 of the processor unit 110 may latch the received write command. The non-volatile memory device 120 may complete execution of a first write operation and the mode controller 112 may transmit the received write command to the non-volatile memory device 120. The mode controller 112 may latch the second write command to prevent a second command from a pipelining sequence from being lost when the operation of the processor 113 stops.

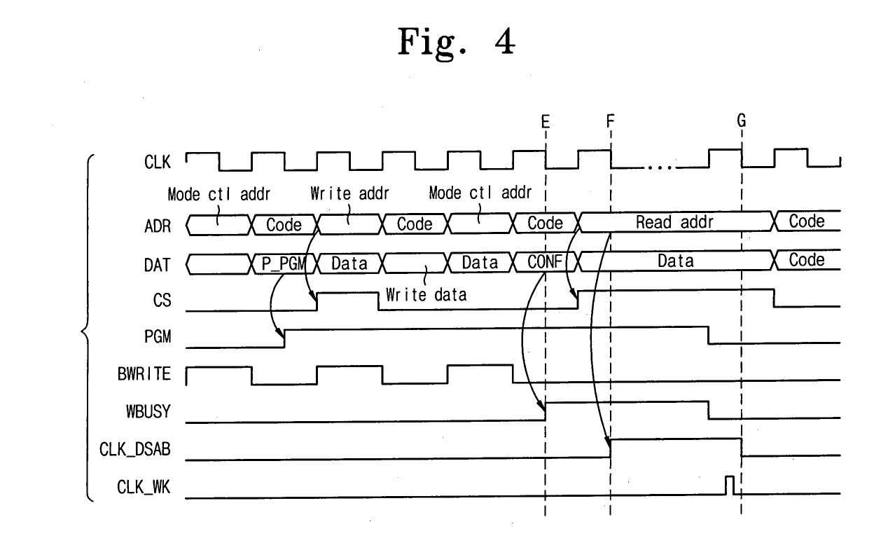

FIG. 4 illustrates another example timing diagram of signals for the information processing apparatus 100 of FIG. 1. In this example, the processor unit may sequentially output a write command and a read command to the memory bank-0 121 of the non-volatile memory device 120. Further, in this example, the timing diagram of FIG. 4 is identical to the timing diagram of FIG. 3 until time E of FIG. 4 and/or time A of FIG. 3. Thus, FIG. 4 will now be described with reference to operation after time E. It may also be assumed, within this example, that a write address designates a memory of the bank-0 121.

Referring to FIG. 4, at time F, the chip-selecting signal CS may be set at the first logic level. When the busy signal WBUSY from the write sequence controller 139 is at the first logic level and the write signal BWRITE is at the second logic level, the state controller 140 may confirm an input read address ADR. Since the memory cell of the bank-0 121 may store a previous program command, the state controller 140 may activate the clock disable signal CLK_DSAB to suspend an operation of the processor 113 when the read address ADR designates the bank-0 121. Alternatively, when the read address ADR designates the bank-1 122, the non-volatile memory device 120 may perform a read operation for the bank-1 122 simultaneously with a program operation (e.g., write/read/erase operation) for the bank-0 121.

In the interval between time F and time G, the program operation for the bank-0 121 may complete execution. The write sequence controller 139 may set the busy signal WBUSY to the second logic level and may set the clock wake-up signal CLK_WK to the first logic level. The second flip-flop circuit 151 of the mode controller 112 may be reset in response to the busy signal WBUSY. The program signal PGM may be set to the second level. The read address ADR (e.g., received from an address bus) may be stored in the first read address 134.

At time G, the state controller 140 may set the clock disable signal CLK_DSAB to the second logic level at the falling edge of the clock signal CLK. The clock generator 114 may regenerate the clock signal CLK. The processor 113 may operate synchronously with respect to the clock signal CLK.

The write sequence controller 139 may inform the first address selector 133 of a write operation termination, and the first address selector 133 may output the read address stored in the first read address buffer 134 to the first controller 129. The first controller 129 may set the first sense amplifier 125 to sense data stored in a memory cell designated by a read address received from the first address selector 133. The data sensed by the first sense amplifier 125 may be output to the processor unit 110.

Thus, in response to a write command from the processor unit 110, the non-volatile memory device 120 may stop the clock generation of the clock generator 114 (e.g., when a read address for executing a read operation for the bank-0 121 is transmitted to the non-volatile memory device 120 while the non-volatile memory device 120 executes a write operation for the bank-0 121), thereby suspending the operation of the processor 113. When the write operation is terminated, the non-volatile memory device 120 reads out data stored in a read address and may output the data to the processor unit 110.

The non-volatile memory device 120 may execute a write operation (e.g., in response to a write command from the processor unit 110) for the bank-0 121 and/or a read operation for the bank-1 121. Thus, the non-volatile memory device 120 may execute a read operation for the bank-1 122 simultaneously with a write operation for the bank-0 121 without stopping the operation of the processor 113.

Further, while above-described examples illustrate a write operation being executed on the bank-1 122 and a read operation on the bank-0 122, it is understood that either a write command or a read command may be executed concurrently on either of the memory banks 122. Thus, when a write command and a read command are scheduled for operation on a same bank, the non-volatile memory device 120 may suspend the operation of the processor 113. Alternatively, when a write command and a read command are scheduled for operation on different banks, the write and read commands may be executed at the same time.

In another example embodiment of the present invention, referring to the information processing apparatus 100 of FIG. 1, program code may be stored in a code memory of the processor unit 110 and data may be stored in banks 121 and 122 of the non-volatile memory device 120. FIG. 4 illustrates an alternative example embodiment illustrating a timing diagram including signals used in the information processing apparatus 100 where a memory may not be included in the processor unit 110. Accordingly, in the alternative example embodiment, the bank-0 and the bank-1 of the non-volatile memory device may be used to store both data and/or program code.

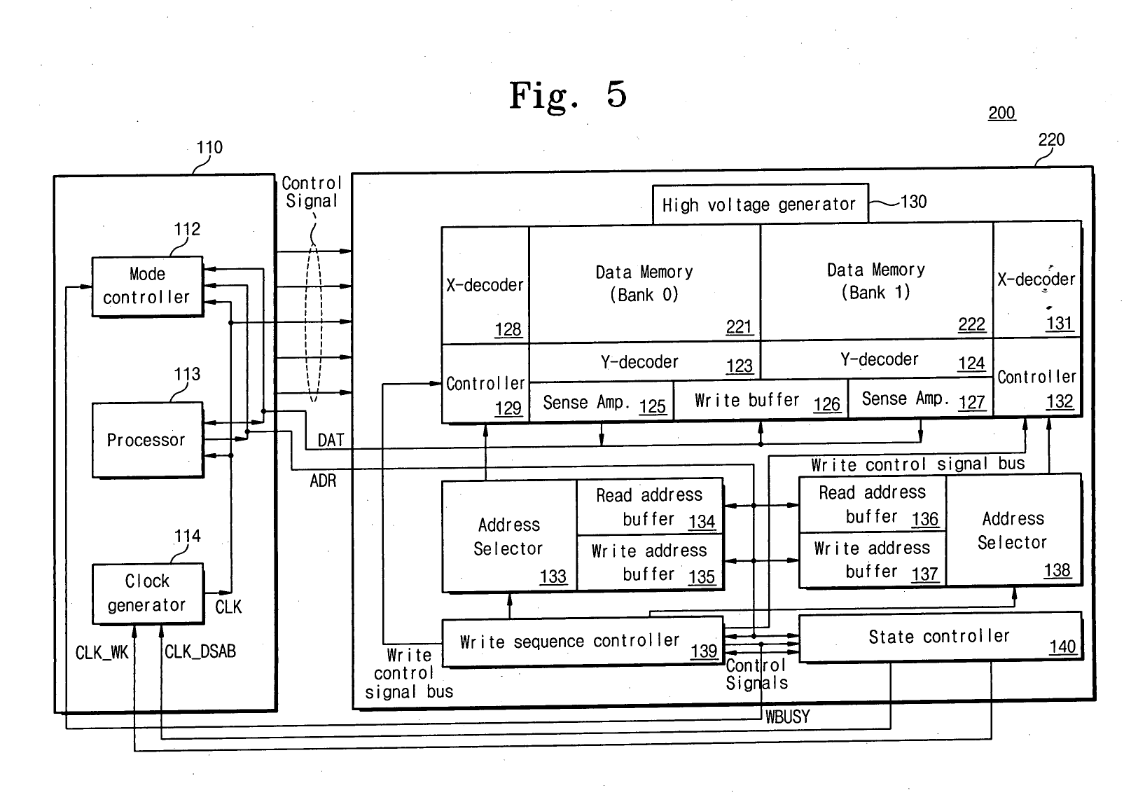

FIG. 5 illustrates a block diagram of another information processing apparatus 200 according to an example embodiment of the present invention. Referring to the information processing apparatus 200 of FIG. 5, an operation of the information processing apparatus 200 may function similarly to that of the above-described information processing apparatus 100 of FIG. 1, with an exception to the similar operation being that a code memory 222 may not be included in the processing unit 210. In this example embodiment, program code may be stored in a bank-1 222 of the non-volatile memory device 220. The processor 113 may execute program code read out from the code memory 222 and data may be stored in a data memory 221.

In another example embodiment of the present invention, referring to FIG. 5, since the program code may not be stored in the processor 113, a next instruction from the program code may be fetched without stopping operation of the processor 113. In this manner, the efficiency of the pipelined execution of commands for the processor 113 may be increased.

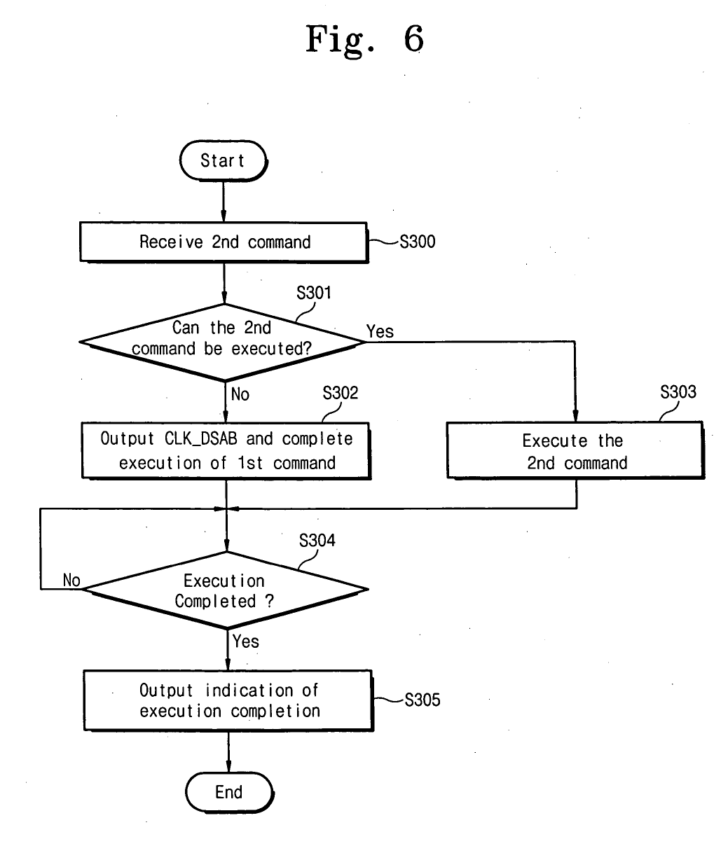

FIG. 6 illustrates a flow chart of a process according to an example embodiment of the present invention.

In another example embodiment of the present invention, although the process illustrated in FIG. 6 is below-described with reference to the non-volatile memory device 120 of FIG. 1, process may be applicable to any non-volatile memory device (e.g., non-volatile memory device 220 of FIG. 5).

Referring to FIG. 6, in S300, the non-volatile memory device 120 may receive a second command from the processor unit 110 while executing a first command (e.g., a write command, a read command, etc.). Since the processor unit 110 is executing the second command (e.g., a write command, a read command, etc.), the write sequence controller 139 may activate a busy signal WBUSY.

In S301, the state controller 140 of the non-volatile memory device 120 may determine whether the second command may be executed. As previously discussed, two simultaneous write commands may not be performed simultaneously on a same bank. Thus, if the first command and second command are write commands for a same bank, the process may proceed to S302. In S302, the first controller 129 may activate (e.g., set to the first logic level or the second logic level) a signal (i.e., a clock disable signal CLK_DSAB) indicating that the second write command may not be executed. The process may then proceed to S304.

Alternatively, in step S301, if the second command may be executed (e.g., the first and second commands are not write and/or read commands for a same bank), the process may proceed to S303. In S303, the non-volatile memory device 120 may execute the second command simultaneously with the first command. The process may then proceed to S304.

In S304, the write sequence controller 130 of the non-volatile memory device 120 may determine whether a write operation (e.g., the first command, the second command, etc.) for the bank-0 120 has finished execution. When the write operation for the bank-0 120 is completed, the process may proceed to S305.

In S305, the write sequence controller 130 of the non-volatile memory device 120 may set the busy signal WBUSY to the second logic level. The state controller 140 may activate a clock wake-up signal CLK_WK based on the state of the busy signal WBUSY when the clock disable signal CLK_DSAB is at the first logic level.

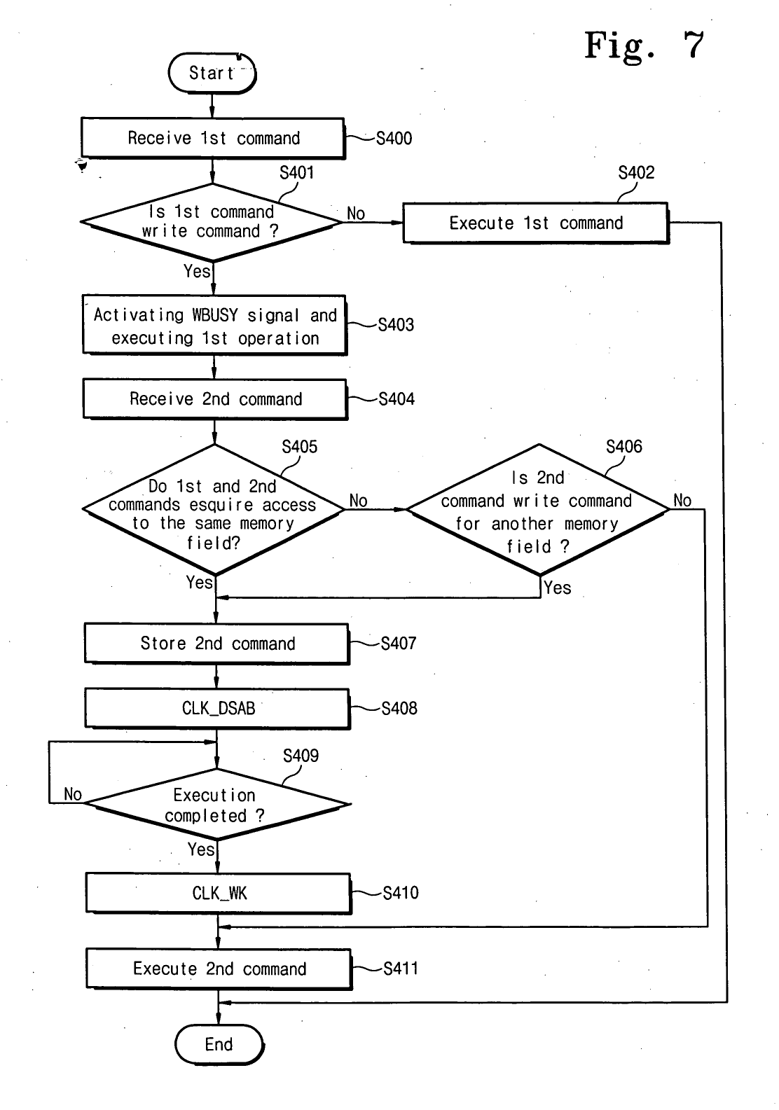

FIG. 7 illustrates a flow chart of another process according to another example embodiment of the present invention.

In another example embodiment of the present invention, although the process illustrated in FIG. 7 is below-described with reference to the non-volatile memory device 120 of FIG. 1, the process may be applicable to any non-volatile memory device (e.g., non-volatile memory device 220 of FIG. 5).

In S400, the non-volatile memory device 120 may receive a first command from the processing unit 110. In S401, the write sequence controller 130 may determine whether the first command is a write command (e.g., based on a logic level of the write signal BWRITE). If the write signal BWRITE is at the first logic level when the chip-selecting signal CS is activated, the write sequence controller 139 may determine the first command to be a write command. Alternatively, if the write signal BWRITE is at the second logic level, the write sequence controller 139 may determine the first command to be a read command.

If it is determined in S401 that the first command is a read command, the process may proceed to S402. In S402, the write sequence controller 139 may receive a confirmation signal CONF from the processor 113. The write sequence controller 139 may set the first address selector 133 and the first controller 129 to execute the first command (i.e., the write command).

If it is determined in S401 that the first command is a write command, the process may proceed to S403. In S403, the write sequence controller 139 may set the busy signal WBUSY to the first logic level, and may set the first address selector 133 and the first controller 129 to execute the received write command. The busy signal WBUSY may be output to the state controller 140 and/or the mode controller 112 of the processing unit 110.

In S404, the non-volatile memory device 120 may receive a second command while executing the first command. In S405, the write sequence controller 139 may determine whether the second command requires bank access (e.g., a write command, an erase command, a read command, etc.). If an address signal ADR associated with the second command designates a bank which is executing a write command the process may proceed to 407. If the address signal ADR associated with the second command does not designate the bank which is executing a write command, the process may proceed to S406.

In S406, the write sequence controller 139 may determine whether the second command is a write command. Example methods of determining whether a command is a write command are described above. If the second command is not a write command, the process may advance to 411. In 411, the second command may be executed. Alternatively, when the second command is a write command, the process may proceed to S407.

In S407, the second command may be latched (i.e., stored) to the first flip-flop circuit 150. In S408, the state controller 140 may activate (i.e., set to the first logic level) a clock disable signal CLK_DSAB for stopping a clock generation of the clock generator 114, which may thereby stop the operation of the processor 113. The first command may then begin execution.

In S409, the write sequence controller 139 may determine when the first command completes execution. When the first command completes execution, the write sequence controller 139 may set the busy signal WBUSY to the second logic level.

In S410, after the busy signal WBUSY is set to the second logic level, the state controller 140 the clock wake-up signal CLK_WK may set the clock generator 114 to regenerate the clock signal. The processor 113 may then receive the regenerated clock signal CLK.

In S411, the mode controller 112 may output the second command latched in the first flip-flop circuit 150 to the non-volatile memory device 120. The non-volatile memory device 112 may then execute the second command.

In another example embodiment of the present invention, a non-volatile memory device may execute a write operation at a first memory field in response to a first command. The non-volatile memory device may receive a second command for an access request (e.g., a write command, read command, erase command, etc.) for the first memory field or a write operation of a second memory field, an operation of the processor may be suspended (i.e., stopped or paused temporarily). When the second command is a write command, the second command may be latched onto the mode controller. When the first command completes execution, an operation of the stopped processor may reinitiate and the second command may be executed. Therefore, when the non-volatile memory device executes the write operation, the processor requests an access for the non-volatile memory device, which may prevent a malfunction of the processor.

The example embodiments of the present invention being thus described, it will be obvious that the same may be varied in many ways. For example, while the above-described example embodiments include references to the first and second logic levels, in one example the first logic level may refer to a high logic level and the second logic level may refer to a low logic level. Alternatively, in another example, the first logic level may refer to a low logic level and the second logic level may refer to a high logic level.

Such variations are not to be regarded as departure from the spirit and scope of the example embodiments of the present invention, and all such modifications as would be obvious to one skilled in the art are intended to be included within the scope of the following claims.

What is claimed is:

1. A non-volatile memory device comprising:
a controller for outputting at least one signal to an external device, the at least one signal indicating whether a memory cell array executing a first command is available to execute a second command, the first command being a write command.

2. The non-volatile memory device of claim 1, wherein the memory cell array includes a first field and a second field.

3. The non-volatile memory device of claim 2, wherein the at least one signal indicates that the second command cannot be executed when the second command requires access to the first field and the first command requires access to the first field.

4. The non-volatile memory device of claim 2, wherein the first and second fields include data.

5. The non-volatile memory device of claim 4, wherein the at least one signal indicates that the second command cannot be executed when the second command is a write command requiring access to the second field and the first command requires access to the first field.

6. The non-volatile memory device of claim 4, wherein the second command begins execution before the first command completes execution when the second command is a read command requiring access to the second field and the first command requires access to the first field.

7. The non-volatile memory device of claim 2, wherein the first field includes data and the second field includes program code.

8. The non-volatile memory device of claim 2, wherein the first field includes program code and the second field includes data.

9. The non-volatile memory device of claim 1, wherein the signal includes state information to the external device, the state information indicating whether the memory array is executing a write command.

10. The non-volatile of claim 9, wherein the at least one signal indicates when the first command completes execution.

11. An information processing apparatus comprising:
a processor unit;
a non-volatile memory device including a memory cell array;
a clock generator for generating a clock signal, the generation of the clock signal stopping in response to a clock disable signal; and
a controller for activating the clock disable signal when the memory cell array is not available to execute a first command received from the processor unit.

12. The information processing apparatus of claim 11, wherein the memory cell array includes first and second fields.

13. The information processing apparatus of claim 12, wherein the controller activates the clock disable signal when the first command requires access to the second field and a second command is being executed at the second field.

14. The information processing apparatus of claim 12, wherein the first and second fields include data.

15. The information processing apparatus of claim 11, wherein the first command is one of a write command, an erase command and a read command.

16. The information processing apparatus of claim 13, wherein the first command is one of a write command, an erase command and a read command.

17. The information processing apparatus of claim 12, wherein the controller activates the clock disable signal when the first command is a write command requiring access to the first field and a second command is being executed at the second field, the second command being a write command.

18. The information processing apparatus 12, wherein the first field includes program code and the second field includes data.

19. The information processing apparatus 12, wherein the second field includes program code and the first field includes data.

20. The information processing apparatus of claim 12, wherein the controller outputs a busy signal to maintain an active state in the memory cell array when data is written into the memory cell array.

21. The information processing apparatus of claim 20, wherein the processor unit includes a mode controller for storing the first command when the memory cell array is in the active state in response to the busy signal.

22. The information processing apparatus of claim 11, wherein the clock generator regenerates the clock signal in response to a clock wake-up signal.

23. The information processing apparatus of claim 22, wherein the controller activates the clock wake-up signal when a busy signal changes to an inactive state and a clock disable signal is in an active state.

24. The information processing apparatus of claim 21, wherein the mode controller outputs the stored first command to the non-volatile memory device when the busy signal changes from an active state to an inactive state.

25. A method for controlling a non-volatile memory device, comprising:
receiving a first command at a non-volatile memory device; and
outputting at least one signal to an external device, the at least one signal indicating that the first command may be executed when the non-volatile memory device is not executing a second command and indicating that the first command may not be executed when the non-volatile memory device is executing the second command.

26. The method of claim 25, wherein the first and commands are write commands.

27. The method of claim 25, wherein the memory cell array includes a first field and a second field.

28. The method of claim 27, wherein the at least one signal indicates that the first command cannot be executed when the first command requires access to the first field and the execution of the second command requires access to the first field.

29. The method of claim 27, wherein the first and second fields include data.

30. The method of claim 29, wherein the at least one signal indicates that the first command cannot be executed when the first command is a write command requiring access to the second field and the second command is a write command requiring access to the first field.

31. The method of claim 30, wherein the at least one signal indicates that the first command and second command may be executed simultaneously when the first command is a read command requiring access to the second field and the second command is a write command requiring access to the first field.

32. The method of claim 27, wherein the first field includes program code and the second code includes data.

33. The method of claim 27, wherein the second field includes program code and the first code includes data.

34. The method of claim 25, wherein the at least one signal includes state information to the external device, the state information indicating whether the memory array is executing a write command.

35. The method of claim 34, wherein the at least one signal indicates when the second command completes execution.

36. A method for processing, comprising:
transmitting a first command to a non-volatile memory device from a processor unit before the non-volatile memory device completes execution for a write operation; and
pausing an operation of the processor unit in response to at least one signal received from the non-volatile memory device, the at least one signal indicating that the non-volatile memory device cannot execute the first command until the write operation completes execution.

37. The method as set forth in claim 36, wherein the non-volatile memory device includes a memory cell array including a first field and a second field.

38. The method of claim 37, wherein the processor unit includes a clock generator for generating a clock signal which synchronizes an operation of the processor unit, the clock generator receiving a clock disable signal for pausing operation of the processor unit by stopping the generation of the clock signal, the at least one signal include the clock disable signal.

39. The method of claim 37, wherein the clock disable signal is output by the non-volatile memory device when the first command requires access to the first field and the write operation requires access to the first field.

40. The method of claim 37, wherein the first and second fields include data.

41. The method of claim 38, the non-volatile memory device outputs the clock disable signal when the first command is a write command requiring access to the second field and the write operation requires access to the first field.

42. The method of claim 37, wherein the first command begins execution during the write operation when the first command is a read command requiring access to the second field and the write operation requires access to the first field.

43. The method of claim 37, wherein the first field includes data and the second fiend includes program code.

44. The method of claim 37, wherein the second field includes data and the first field includes program code.

45. The method of claim 36, further comprising:
outputting a busy signal until the write operation completes execution.

46. The method of claim 45, further comprising:
storing the first command when the first command is a write command.

47. The method of claim 46, further comprising:
activating a clock wake-up signal when the busy signal enters an inactive state and the clock disable signal is in an active state.

48. The method of claim 47, further comprising:
regenerating the clock signal in response to the clock wake-up signal; and
outputting the stored first command.

49. The method of in claim 46, wherein a mode controller outputs the stored first command to the non-volatile memory device when the busy signal changes from an active state to an inactive state.

50. An information processing apparatus, comprising:
a processor unit; and
the non-volatile memory device of claim 1.

51. An information processing apparatus for performing the method of claim 25.

52. An information processing apparatus for performing the method of claim 36.

53. A non-volatile memory device for performing the method of claim 25.

54. A non-volatile memory device for performing the method of claim 36.
